(19) United States
(12) Patent Application Publication
(10) Pub. No.: US 2007/0105707 A1
(43) Pub. Date: May 10, 2007

(54) Method for manufacturing honeycomb structure

(75) Inventor: Yukihito Ichikawa, Nagoya-city (JP)

Correspondence Address: OLIFF & BERRIDGE, PLC, P.O. BOX 19928, ALEXANDRIA, VA, 22320, US

(73) Assignee: NGK INSULATORS, LTD., NAGOYA-CITY (JP)

(21) Appl. No.: 11/591,497

(22) Filed: Nov. 2, 2006

(30) Foreign Application Priority Data
Nov. 10, 2005 (JP) 2005-326112

(51) Int. Cl. C04B 33/00; B28B 1/00

(52) U.S. Cl. 501/141; 428/116; 264/630

(57) ABSTRACT

There is provided a method for manufacturing a honeycomb structure, wherein a raw material containing Al₂O₃ is used as the ceramic raw material, and a low melting point reacting substance is allowed to be contained in the clay at least before being formed to obtain a honeycomb structure having a mean pore diameter of 20 to 500 μm as the honeycomb structure. According to this method for manufacturing a honeycomb structure, it is possible to manufacture a honeycomb structure suitable for realizing a honeycomb catalyst body excellent in purification efficiency, having low pressure loss, and mountable even in a limited space.

### BACKGROUND OF THE INVENTION AND RELATED ART STATEMENT

The present invention relates to a method for manufacturing a honeycomb structure capable of serving as a honeycomb catalyst body suitably used for purifying components to be purified such as carbon monoxide contained in exhaust gas exhausted from an automobile engine, or the like, by loading a catalyst.

A catalyst body (honeycomb catalyst body) where a catalyst is loaded on a honeycomb structure is used in order to purify exhaust gas exhausted from various kinds of engines, or the like. As shown in FIG. 6, a honeycomb catalyst body has a structure where a catalyst layer 15 is loaded on a surface of the partition walls 4 forming the cell 3. As shown in FIGS. 4 and 5, exhaust gas can be purified by sending the exhaust gas into the cells 3 from one end face 2a side of the honey comb catalyst body 60 (honeycomb structure 11) to bring the exhaust gas into contact with a catalyst layer (not illustrated) on a surface of the partition walls 4, and exhausting the exhaust gas outside from the other end face 2b side (see Patent Document 1).

When exhaust gas is purified by the use of a honeycomb catalyst body, it is preferable that a hydraulic diameter of the cells is decreased and that a surface area of the partition walls is increased to accelerate transmission of components to be purified contained in exhaust gas from the exhaust gas toward a catalyst layer on the surface of the partition walls as much as possible in order to enhance purification efficiency. In order to realize this, there is employed a method where the number of cells per unit area (cell density) is increased. It has been known that transmissibility of components to be purified toward a catalyst layer on a surface of the partition walls from exhaust gas increases in inverse proportion to the square of the hydraulic diameter of the cells. The higher the cell density is, the higher the transmissibility of components to be purified becomes. However, since pressure loss tends to increase in inverse proportion to the square of the hydraulic diameter of the cells, there arises a problem of increase in pressure loss according to rise in transmissibility of components to be purified.

It has been known that, in the case that a diffusion rate of components to be purified in a catalyst layer is insufficient, purification efficiency of the honeycomb catalyst body tends to deteriorate. Therefore, in order to enhance purification efficiency, it is preferable not only to increase a surface area of the catalyst layer but also to reduce thickness of the catalyst layer, which is generally about several tens μm, on the surface of the partition walls to raise the diffusion rate of components to be purified in a catalyst layer. Though this makes increase in cell density and surface area of a catalyst layer easy to raise transmissibility of the components to be purified, a problem of increase in pressure loss is not solved (see Patent Document 2 and Patent Document 3 with respect to a measure against increase in pressure loss).

Further, it is possible to reduce pressure loss with keeping or improving purification efficiency of exhaust gas by lowering the flow rate of the exhaust gas to be circulated by increasing an inlet diameter of a honeycomb catalyst body. However, in the case that a honeycomb catalyst body becomes large-scale, there remains the problem that mounting a large-scaled honeycomb catalyst body on an automobile becomes difficult because a space for mounting the honeycomb catalyst body is limited.

[Patent Document 1] JP-A-2003-33664

[Patent Document 2] JP-A-2002-301323

[Patent Document 3] JP-B-3-10365

### SUMMARY OF THE INVENTION

The present invention has been made in view of the problems of the prior art and aims to provide a method for manufacturing a honeycomb structure suitable for realizing a honeycomb catalyst body excellent in purification efficiency, having low pressure loss, and mountable even in a limited space. As a result of incentive study, it has been found out that a honeycomb catalyst body excellent in purification efficiency and mountable even in a limited space can be obtained by loading a catalyst layer on an inside surface of the cells and on the inside surface of the pores in partition walls of a honeycomb structure. In addition, it was considered that, in order to satisfy the condition of low pressure loss and to obtain a surface area sufficient for realizing high purification efficiency, a pore diameter of partition walls of a honeycomb structure functioning as a catalyst carrier is made large enough to allow exhaust gas to pass through the partition walls and is kept within a certain range. Moreover, a means suitable for manufacturing such a honeycomb structure was found, which led to the completion of the present invention. Concretely, according to the present invention, the following means to solve the problems can be provided.

First, according to the present invention, there is provided a method for manufacturing a honeycomb structure comprising the steps of: mixing and kneading a material for clay containing a ceramic raw material, a binder, and water to obtain clay, forming the clay into a honeycomb shape having a plurality of cells communicating between two end faces thereof and being formed with partition walls to obtain a honeycomb formed body, and firing the honeycomb formed body to obtain a honeycomb structure; wherein a raw material containing Al₂O₃ is used as the ceramic raw material, and a low melting point reacting substance is allowed to be contained in the clay at least before being formed to obtain a honeycomb structure having a mean pore diameter of 20 to 500 μm as the honeycomb structure.

Cordierite ceramic is generally used for a honeycomb structure as a catalyst carrier. In a cordierite-forming raw material, since each component is blended so as to obtain a theoretical composition of a cordierite crystal (42 to 56 parts by mass of silica (SiO₂), 30 to 45 parts by mass of alumina (Al₂O₃), and 12 to 16 parts by mass of magnesia (MgO) as a chemical composition), a silica source component, a magnesia (MgO) source component and the like are contained besides an alumina source component.

In a method for manufacturing a honeycomb structure of the present invention, it is preferable that the low melting point reacting substance is powdery or fibrous and that the size of powdery particle or that of a fiber is 10 to 200 μm.

In a method for manufacturing a honeycomb structure of the present invention, it is preferable that the low melting point reacting substance is a metal. In this case, it is preferable that the metal is one metal, an alloy containing as a main component at least one metal (In case of iron, for example, carbon steel, cast iron, or stainless steel falls.), or an alloy containing as a main component two or more metals selected from the group consisting of iron, copper, zinc, lead, aluminum, and nickel. Further, it is preferable that the metal is a balloon-shape having a hollow or porous. Moreover, it is preferable that the shape of particle is a fine and long shape like a fiber.

In addition, in a method for manufacturing a honeycomb structure of the present invention, it is preferable that a low melting point reacting substance is added to the ceramic raw material in advance to allow the low melting point reacting substance to be contained in the clay at least before being formed. Examples of a material containing Al₂O₃ except for cordierite include alumina, mullite, lithium aluminum silicate, and aluminum titanate. By adding a silica raw material or the like to an alumina raw material, reaction with a low melting point reacting substance is accelerated more, compared with the cases where no such an addition is made.

Further, in a method for manufacturing a honeycomb structure of the present invention, it is preferable to use a mold to form the green body and make the low melting point reacting substance contained in clay by disposing a screen made of the low melting point reacting substance before a die for molding apparatus so as to make the clay pass through the screen prior to extrusion of the clay from the die. In this case, a means of adding a low melting point reacting material to the above ceramic raw material in advance can be employed together.

A method for manufacturing a honeycomb structure of the present invention is a means of obtaining a honeycomb structure having a mean pore diameter of 20 to 500 μm. When the mean pore diameter of a honeycomb structure is below 20 μm, pressure loss tends to increase On the other hand, when the mean pore diameter of a honeycomb structure is above 500 μm, it is apprehended that a contact area of a catalyst layer with exhaust gas cannot sufficiently be secured. In addition, there is an influence of lowering contact probability of exhaust gas components passing through the pores with a catalyst layer in an inside surface of the pores. Incidentally, a mean pore diameter of the present specification is an average value of pore diameters (physical property value) measured by image analysis. At least 20 visions of a SEM photograph of a cross-section of a partition wall are observed with respect to a vision of length×breadth=T×T in the case of defining thickness of a partition wall as T. In each of the visions, the maximum distance in a gap is measured, and the average value of the maximum distances measured with respect to all the visions is defined as the mean pore diameter. A more preferable mean pore diameter of the honeycomb structure is 30 to 200 μm.

A method for manufacturing a honeycomb structure of the present invention is suitable as a means of obtaining a honeycomb structure having a porosity of 40 to 80%. When the honeycomb structure is applied to a catalyst body, the honeycomb structure preferably has a porosity of 60 to 70%, and more preferably almost 65%. This is because the porosity of 40 to 80% decreases thermal capacity in addition to lowering pressure loss, and enables to maintain mechanical strength as a structure. Incidentally, porosity referred to in the present invention is a physical property value measured by image analysis. At least 5 visions of a SEM photograph of a cross-section of a partition wall are observed with respect to a vision of length×breadth=T×T in the case of defining thickness of a partition wall as T. In each of the visions, proportion of a gap area is measured and raised to three seconds power to give a value. The average value of the values with respect to all the visions is defined as the porosity.

A method for manufacturing a honeycomb structure of the present invention is suitable as a means of obtaining a honeycomb structure having a partition wall thickness of 50 to 2000 μm. When the honeycomb structure is applied to a catalyst body, the honeycomb structure preferably has a thickness of 50 to 1000 μm, more preferably 200 to 700 μm, and particularly preferably almost 430 μm (almost 17 mil). When the partition wall thickness is below 50 μm, strength is insufficient, and sometimes thermal shock resistance is reduced. On the other hand, when the partition wall thickness is above 2000 μm, pressure loss tends to increase. Incidentally, one mil means one thousandth of 1 inch, which is about 0.025 mm.

A method for manufacturing a honeycomb structure of the present invention is suitable as a means of obtaining a honeycomb structure having a cell density of 20 to 1500 cells/in² (cpsi). When the honeycomb structure is applied to a catalyst body, the honeycomb structure preferably has a cell density of 40 to 900 cpsi, more preferably 60 to 400 cpsi, and particularly preferably almost 100 cpsi. When the cell density is below 20 cpsi, contact efficiency with exhaust gas tends to be insufficient. On the other hand, when the cell density is above 1500 cpsi, pressure loss tends to increase rapidly. Incidentally, “cpsi” is an abbreviation of “cells per square inch” and a unit representing the number of cells per square inch. Ten cpsi is about 1.55 cells/cm².

A honeycomb structure to be manufactured by a method for manufacturing a honeycomb structure of the present invention is provided with partition walls separating a plurality of cells extending in an axial direction. In a step of forming a honeycomb formed body provided with partition walls separating a plurality of cells extending in an axial direction by extrusion forming upon manufacturing this honeycomb structure, partition walls having a curved shape in a cross-section perpendicular to the aforementioned axial direction can be formed by subjecting the central portion and the outer peripheral portion of the extrusion face to extrusion forming at a mutually different speed. This enables to obtain a honeycomb structure where the cell density is continuously changed smoothly from the central portion to the outer peripheral portion. Therefore, depending on the usage, properties to which importance is attached, and other structural factors (cell density, partition wall thickness, etc.), a honeycomb structure having higher cell density in the central portion than in the outer peripheral portion or a honeycomb structure having an inverse structure can be obtained. By such a honeycomb structure, low pressure loss and high purification ability can be compatible with each other.

Next, according to the present invention, there is provided a method for manufacturing a honeycomb catalyst body, wherein a plugged portion is formed so as to plug the cells of the honeycomb structure on any of the end faces after the honeycomb structure is obtained in a method for manufacturing any of the aforementioned honeycomb structures, and a catalyst layer is formed on an inside surface of the cells, and an inside surface of the pores in the partition walls forming the cells to obtain a honeycomb catalyst body.

A method for manufacturing a honeycomb structure of the present invention is a manufacturing method where a low melting point reacting substance is mixed in clay at least before being formed. According to this method, if a powdery or fibrous low melting point reacting substance is included in the low melting point reacting substance mixed in the clay, the low melting point reacting substance melts at low temperature and reacts with the peripheral cordierite-forming raw material, which enables to form pores larger than the size of the low melting point reacting substance. That is, the low melting point reacting substance functions as a pore former. In addition, the low melting point reacting substance accelerates melting of the peripheral cordierite-forming raw material (e.g., talc) at low temperature, and pores formed by the cordierite-forming raw material can be made larger. Further, if a fibrous low melting point reacting substance is included in the low melting point reacting substance, pores which make pores formed by the cordierite-forming raw material communicate with one another are formed, which enables to construct a mesh pore structure. Therefore, a honeycomb structure having a mean pore diameter of 20 to 500 μm can be obtained stably and securely.

Incidentally, Patent Document 3 shows an example of mixing iron powder in a raw material in Example 6 as an example of an exhaust gas purification filter. However, since pores formed are through-holes of 100 to 250 μm passing through partition walls, a large number of pores cannot be formed. Judging from FIG. 4 showing a pore distribution of Example 6 in Patent Document 3, there is no pore having a diameter of 100 μm or more, and it can be understood that the through-holes formed by iron powder are a very small number of pores which do not appear in the accumulative pore capacity in FIG. 4. In addition, since they pass through the walls, it is not a preferable mode in the case of being used as a catalyst body from the view point of contact efficiency of the inside surface of the pores of the partition walls with exhaust gas.

In contrast, since a method for manufacturing a honeycomb structure of the present invention preferably employs a powdery or fibrous low melting point reacting substance, whose particle diameter is controlled in a predetermined range, not only through-holes but also a large number of pores which do not pass through a partition wall by itself.

A honeycomb catalyst body obtained by forming a catalyst layer on the inside surface of the cells and inside surface of the pores in the partition walls forming the cells of the honeycomb structure obtained by a method for manufacturing a honeycomb structure of the present invention has a large surface area of the catalyst layer without increasing the inlet diameter, has improved transmission of components to be purified contained in exhaust gas, is excellent in purification efficiency, is capable of being disposed even in a limited space, and is mountable. In addition, since this honeycomb structure has a large pore diameter where exhaust gas can pass the partition walls and a pore diameter within a certain range, pressure loss can be suppressed.

### BRIEF DESCRIPTION OF THE DRAWINGS

FIG. 1 is a front view schematically showing an embodiment of a honeycomb catalyst body where a honeycomb structure obtained by the method for manufacturing a honeycomb structure of the present invention is applied.

FIG. 2 is a cross-sectional view schematically showing an embodiment of a honeycomb catalyst body where a honeycomb structure obtained by the method for manufacturing a honeycomb structure of the present invention is applied.

FIG. 3 is a partially enlarged view schematically showing an embodiment of a honeycomb catalyst body where a honeycomb structure obtained by the method for manufacturing a honeycomb structure of the present invention is applied.

FIG. 4 is a front view schematically showing an embodiment of a conventional honeycomb catalyst body.

FIG. 5 is a cross-sectional view schematically showing an embodiment of a conventional honeycomb catalyst body.

FIG. 6 is a partially enlarged view schematically showing an embodiment of a conventional honeycomb catalyst body.

### DESCRIPTION OF REFERENCE NUMERALS

1, 11: honeycomb catalyst body
2a, 2b: end face
3: cell
4: partition wall
5, 15: catalyst layer
10: plugged portion
20: outer wall
25: pore
35: catalyst layer-loaded pore
41: substrate
D: cell hydraulic diameter
P: cell pitch
T: partition wall thickness

### DESCRIPTION OF PREFERABLE EMBODIMENTS

Embodiments of the present invention will hereinbelow be described with suitably referring to drawings. However, the present invention should not be construed with limiting to these embodiments. Various kinds of changes, modification, improvement, and replacement can be added on the basis of knowledge of those skilled in the art in the range of not missing the gist of the present invention. For example, though the drawings show suitable embodiments of the present invention, the present invention is not limited by a mode represented in the drawings or information shown in the drawings. Though, upon carrying or verifying the present invention, the same means or an equal means as or to the one described in the present specification is applied, a suitable means is the means described below.

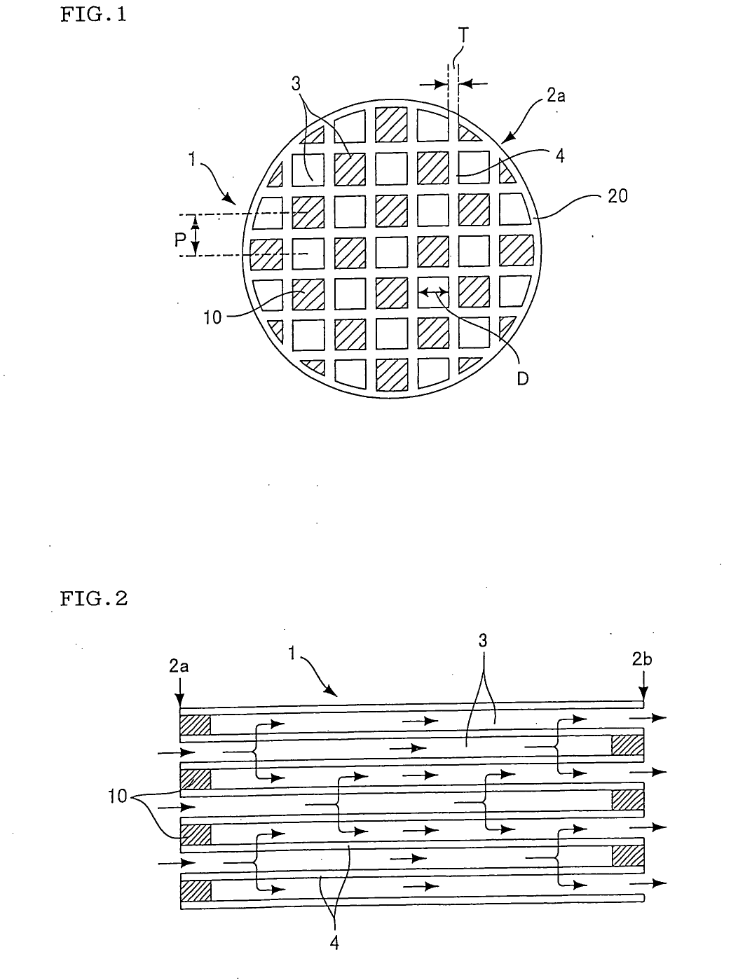

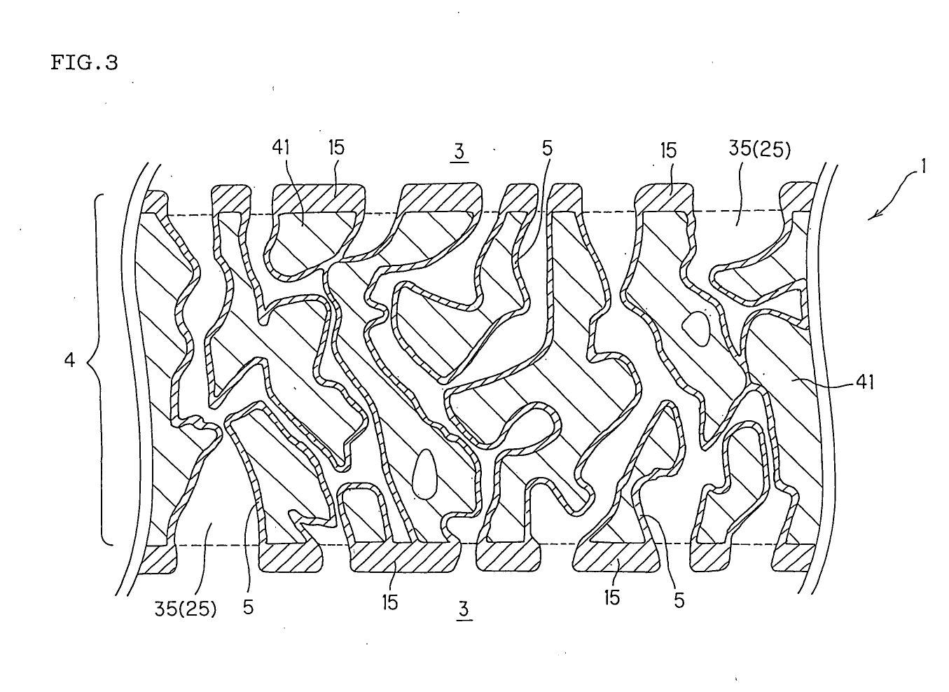

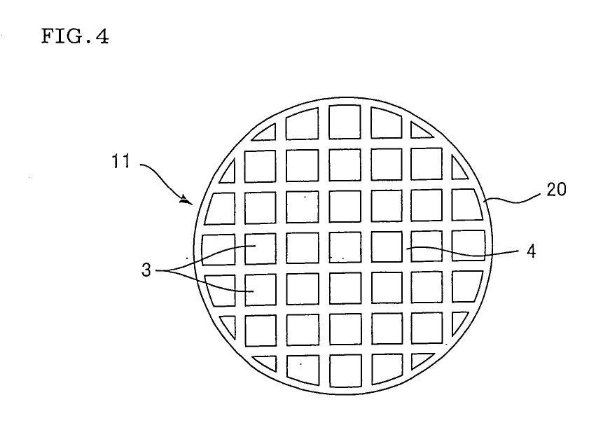

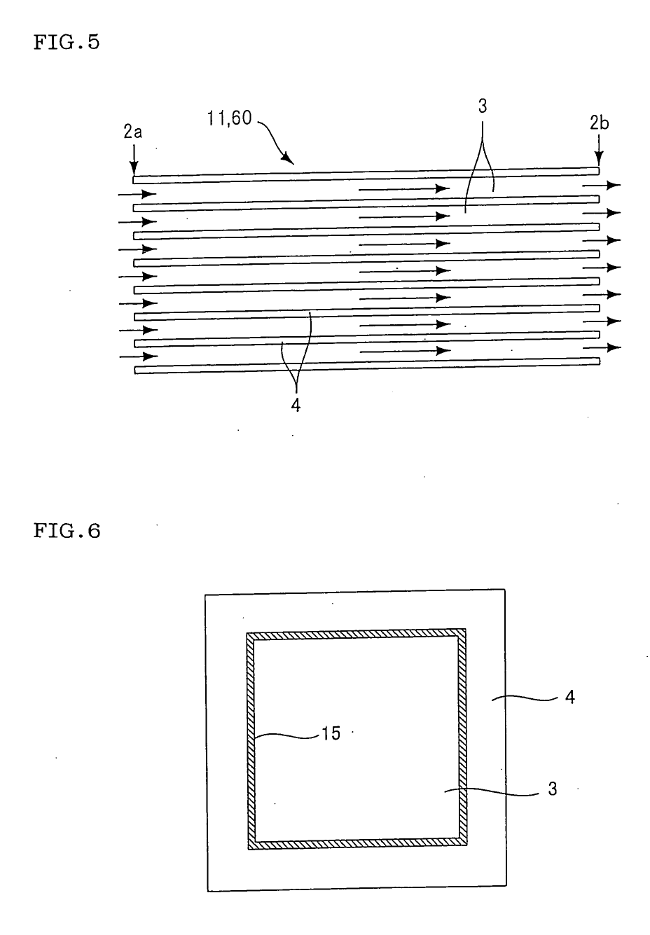

Since a method for manufacturing a honeycomb structure of the present invention is a method for manufacturing a honeycomb structure suitable for realizing a honeycomb catalyst body, a honeycomb structure to be manufactured is first described with the case where it is applied to a honeycomb catalyst body. FIG. 1 is a front view schematically showing an embodiment of a honeycomb catalyst body where a honeycomb structure obtained by the method for manufacturing a honeycomb structure of the present invention is applied. In addition, FIG. 2 is a cross-sectional view schematically showing an embodiment of a honeycomb catalyst body where a honeycomb structure obtained by the method for manufacturing a honeycomb structure of the present invention is applied. Further, FIG. 3 is a partially enlarged view schematically showing an embodiment of a honeycomb catalyst body where a honeycomb structure obtained by the method for manufacturing a honeycomb structure of the present invention is applied.

In a honeycomb catalyst body 1 shown in FIGS. 1 to 3, a plugged portion 10 and catalyst layers 5, 15 are formed on a honeycomb structure where porous partition walls 4 having a large number of fine pores form a plurality of cells 3 passing through between the two end face 2a and 2b. In the honeycomb catalyst body 1, the plugged portion 10 is disposed so as to plug cells 3 in either of the end faces 2a, 2b (see FIGS. 1 and 2). The catalyst layer 5 is loaded in layers on the inside surface of the pores 25. In a partition wall 4, a large number of catalyst-loaded pores 35 through which gas can pass are formed in a substrate 41 portion (see FIG. 3). In addition, the catalyst layer 15 is loaded on the inside surface of the cells 3 in layers. Incidentally, the inside surface of the cells means a surface of a partition wall forming and facing a cell, and the inside surface of the pores means a surface of a partition wall forming and facing a pore. In addition, in FIG. 1, the reference symbols P, D, and T represent cell pitch, cell hydraulic diameter, and partition wall thickness, respectively.

Generally, easiness of transmission of components to be purified contained in exhaust gas when exhaust gas passes through flow channels is in inverse proportion to the square of the hydraulic diameter of the flow channels. In the honeycomb catalyst body 1 (honeycomb structure), a hydraulic diameter of the pores 25 is by far smaller than that of the cells 3. Therefore, in the honeycomb catalyst body 1, components to be purified contained in exhaust gas are transmitted more easily in the catalyst layer 5 loaded on the inside surface of the pores 25 than in the catalyst layer 15 loaded on the inside surface of the cells 3. Therefore, purification efficiency of exhaust gas can be improved by increasing an amount of the catalyst (noble metal) contained in the catalyst layer 5 formed (loaded) on the inside surface of the pores 25 in comparison with an amount of the catalyst (noble metal) contained in the catalyst layer 15 formed (loaded) on the inside surface of the cells 3.

As the catalyst (noble metal) contained in the catalyst layers 5, 15, there is employed a catalyst such as a ternary catalyst for purifying gasoline engine exhaust gas, an oxidation catalyst for purifying gasoline engine or diesel engine exhaust gas, and a SCR catalyst for selectively reducing NOx. More concretely, Pt, Rh, or Pd, or a combination thereof can suitably be used.

Incidentally, though the honeycomb catalyst body 1 has a circular cross-section of a plane perpendicular to the direction of passage of the cells, the honeycomb structure can be manufactured to preferably have a shape suitable for the inside shape of an exhaust gas system where the honeycomb structure is disposed in the case of applying a honeycomb structure to be manufactured to a catalyst body by a method for manufacturing a honeycomb structure of the present invention. Concretely, besides a circle, the shape may be an ellipse, an oval, a trapezoid, a triangle, a rectangle, a hexagon, or an asymmetric deformed shape may be employed.

Next, a method for manufacturing a honeycomb structure of the present invention will hereinbelow be described. First, a cordierite-forming raw material is prepared as a material for clay. Since each component is blended so as to give a theoretical composition of a cordierite crystal, a silica source component, a magnesia source component, an alumina source component and the like are blended therein. Of these, as the silica source component, it is preferable to use quartz or molten silica, and further, the silica component preferably has a particle size of 100 to 150 μm.

It is preferable that the alumina source component contains either aluminum oxide or aluminum hydroxide or both of them because of few impurities. As the alumina source raw material, it is preferable that the cordierite-forming raw material contains 10 to 30% by mass of aluminum hydroxide, and 0 to 20% by mass of aluminum oxide.

Examples of the magnesia source component include talc and magnesite. Of these, talc is preferable. It is preferable that the cordierite-forming raw material contains 37 to 43% by mass of talc, and talc has a particle diameter of preferably 5 to 50 μm, and more preferably 10 to 40 μm. In addition, the magnesia (MgO) source component may contain Fe₂O₃, CaO, Na₂O, K₂O, or the like, as an impurity.

Next, a material for clay (additive) to be added to the cordierite-forming raw material is prepared. As the additive, at least a binder and a pore-former are used, and, besides them, a dispersant and a surfactant are used. It is important in the present invention to employ a low melting point reacting substance as the pore-former. There can preferably be used, as the low melting point reacting substance, one metal, an alloy containing as a main component at least one metal (In case of iron, for example, carbon steel, cast iron, or stainless steel falls.), or an alloy selected from the group consisting of iron, copper, zinc, lead, aluminum, and nickel. The low melting point reacting substance is a powdery or fibrous iron alloy, and the size of powdery particle or that of a fiber is 10 to 200 μm. More concretely, the low melting point reacting substance may have a shape of a sphere, a rolled rhombus, or a confeitos. They are preferable for controlling a shape of a pore. Incidentally, a low melting point reacting substance may be mixed in clay before being formed, or the low melting point reacting substance may be mixed in the clay by allowing the clay to pass through the screen formed of the low melting point reacting substance and disposed in front of the die of the mold used upon forming before the clay is passed through the die.

Examples of the binder include hydroxypropylmethyl cellulose, methyl cellulose, hydroxyethyl cellulose, carboxylmethyl cellulose, and polyvinyl alchohole. Examples of the dispersant include dextrin and polyalcohol. An example of the surfactant is fatty acid soap. Incidentally, the aforementioned additives may be used singly or in combination.

Next, a raw material for the plugged portion is prepared. A material for the plugged portion may be constituted by the material for clay which is the same as that of the honeycomb structure, or may be constituted by a material having a different blend. For example, a ceramic raw material is mixed with a surfactant and water to give a mixture, and as necessary a sintering auxiliary, a pore former, etc., are added to the mixture to obtain slurry, and the slurry is kneaded by the use of a mixer or the like to obtain a raw material for the plugged portion. Examples of the ceramic raw material in the raw material for the plugged portion include α-alumina, calcined bauxite, aluminum sulfate, aluminum chloride, aluminum hydroxide, rutile, anatase-type titanium, ilmenite, electromelting magnesium, magnesite, electromelting spinel, kaolin, silica glass, quartz, and molten silica. Examples of the surfactant include fatty acid soap, fatty acid ester, and polyalcohol.

With respect to 100 parts by mass of the cordierite-forming raw material, 3 to 8 parts by mass of a binder, 3 to 40 parts by mass of a pore former, 0.1 to 2 parts by mass of a dispersant, and 10 to 40 parts by mass of water are mixed. These materials for clay are kneaded to obtain clay.

Next, the clay is formed into a honeycomb shape by extrusion forming, injection forming, press forming, or the like, to obtain a green honeycomb formed body. It is preferable to employ extrusion forming since continuous forming is easy, and, for example, a cordierite crystal can be oriented. Extrusion forming can be conducted by the use of an apparatus such as a vacuum kneader, a ram extrusion-forming machine, and a biaxial screw-type extrusion-forming machine. Then, the plugged portion is formed by a means of, for example, masking a part of the cells on one end face of the green honeycomb formed body, immersing the end face in a raw material for the plugged portion stored in a container to fill the cells having been masked with the raw material for the plugged portion.

Next, the green honeycomb formed body having the plugged portion formed therein is dried. Drying of the honeycomb formed body can be conducted by hot air drying, microwave drying, dielectric drying, reduced pressure drying, vacuum drying, freeze drying, or the like. Since the whole can be dried quickly and uniformly, drying is preferably performed by the combination of hot air drying and microwave drying or dielectric drying. Then, finally, the dried honeycomb formed body is fired. Generally, a honeycomb formed body using a cordierite-forming raw material is fired at a temperature of 1410 to 1440° C. for 3 to 15 hours under an ambient atmosphere. Incidentally, drying and firing may be conducted continuously.

### EXAMPLE

The present invention will hereinbelow be described more concretely by Examples. However, the present invention is by no means limited to these Examples.

### Examples 1 to 8, Comparative Example 1

According to the mean particle diameters and blend proportions shown in Table 1, the main raw material (cordierite-forming raw material) was mixed with pore former to prepare various kinds of raw materials containing a pore former. As shown in Table 1, in Examples 1 to 8, the iron powder as the pore former has a particle size of 30 to 100 μm. On the other hand, in Comparative Example 1, graphite serving as the pore former has a particle size of 150 μm.

Next, with respect to 100 parts by mass of these raw materials, 8 parts by mass of hydroxypropylmethyl cellulose (binder), 0.1 part by mass of lauric acid potash soap (dispersant), and 35 parts by mass of water were added to give a mixture, and the mixture was kneaded to obtain clay having plasticity. Then, the clay was formed into a cylindrical shape using a vacuum kneader and then formed into a honeycomb shape having a predetermined partition wall thickness and a predetermined cell density by the use of extrusion-forming machine to obtain a honeycomb formed body. At this time, the forming state was observed, and forming pressure was confirmed. After thus obtained various kinds of honeycomb formed bodies using different pore formers were subjected to dielectric drying and absolutely dried by hot air drying, they were once fired at 1420° C. for 10 hours to obtain honeycomb structures (sintered bodies) without being plugged.

Next, after both end surfaces, where the cells were open, of each of the honeycomb structures without being plugged were alternatively plugged (in a checkerwise pattern) by the use of slurry consisting of the same raw materials for a plugged portion and blended with the same proportion as the above, the honeycomb structures were fired again at 1420° C. for 4 hours to obtain honeycomb structures having a partition wall thickness and a cell density shown in Table 1 and a size of φ100 mm×100 mm (length). Without forming a catalyst layer on the obtained honeycomb structures, the honeycomb structures were evaluated with respect to the following items. The results are shown in Table 2 with partition wall thickness, cell density, and the results of observing the forming state.

[Porosity]: Porosity was measured by image analysis. At least 5 visions of a SEM photograph of a cross-section of a partition wall were observed with respect to a vision of length×breadth=T×T in the case of defining thickness of a partition wall as T. In each of the visions, proportion of a gap area was measured and raised to three seconds power to give a value. The average value of the values with respect to all the visions was defined as the porosity (see Table 2).

[Mean pore diameter]: Pore diameters were measured by image analysis, and the mean pore diameter was calculated. At least 20 visions of a SEM photograph of a cross-section of a partition wall were observed with respect to a vision of length×breadth=T×T in the case of defining thickness of a partition wall as T. In each of the visions, the maximum distance in a gap was measured, and the average value of the maximum distances measured with respect to all the visions was defined as the mean pore diameter (see Table 2). As shown in Table 2, in Examples 1 to 8, the mean pore diameters were in the range of 50 to 120 μm, and it could be confirmed that each of the honeycomb structures obtained in Examples 1 to 8 was suitable for manufacturing a catalyst body having low pressure loss. On the other hand, in Comparative Example 1, the mean pore diameter was 44 μm. The distribution of pore diameters of the sintered body (a honeycomb structure sintered by firing) is synthesis of distribution of pore diameters formed by the cordierite raw material and distribution of pore diameters formed by the pore former. Since the distribution of pore diameters by the cordierite raw material is relatively small, and the distribution of pore diameters by the pore former is relatively large, the distribution of pore diameters of the sintered body is between them as a result of synthesis. As the results of Examples 1 to 8 and Comparative Example 1, in the case of iron powder, a coarse pore several times larger than iron powder itself is formed by melting reaction. However, in the case of graphite, there is no melting reaction, and the formed pores have almost the same size as graphite itself though it depends on the extent of firing shrinkage. Therefore, the mean pore diameter of the sintered body thus obtained tends to be small in comparison with the mean particle size of graphite, which is the pore former added there.

[Results of observing forming state]: In Comparative Example 1, rise in forming pressure was confirmed. This is considered that the pressure of clay flowing into the die upon forming rose because a pore former having a large mean particle diameter hardly passes through a slit of a forming die, which cannot be evaluated as a preferable state in the point of forming. On the other hand, since, in the Examples 1 to 8, pores having diameters several times larger than particle diameters of iron powder itself are formed, a pore former having a smaller particle size may be sufficient in the case of forming pores having the same size in comparison with graphite (pore former) of Comparative Example 1, which can be evaluated as preferable in the point of forming pressure. In the forming state, no damage in partition walls could be found. When a slit of the forming die is clogged with particles of raw materials or a pore former, a partition wall of the honeycomb formed body is sometimes damaged. Therefore, in order to inhibit damages in partition walls, it is necessary to remove coarse raw material particles, pore former particles, foreign substances, and the like, before the forming die. Since, in the case of iron or the like, a coarse pore several times larger than iron powder itself is formed by a melting reaction, it is advantageous in avoiding damage in a partition wall.

TABLE 1

| | Main raw material | | | | | | Pore former | |
|---|---|---|---|---|---|---|---|---|
| | | | | | Aluminum | Aluminum | Iron | |
| | Talc | Kaolin | Quartz | Molten silica | oxide | hydroxide | powder | Graphite |
| | mass % | mass % | mass % | mass % | mass % | mass % | mass % | mass % |
| | (mean | (mean | (mean | (mean | (mean | (mean | (mean | (mean |
| | particle size) | particle size) | particle size) | particle size) | particle size) | particle size) | particle size) | particle size) |
| Example 1 | 40 (35 μm) | 19 (35 μm) | 12 (116 μm) | — | 14 (6 μm) | 15 (3 μm) | 20 (30 μm) | — |
| Example 2 | 40 (35 μm) | 19 (35 μm) | 12 (116 μm) | — | 14 (6 μm) | 15 (3 μm) | 20 (40 μm) | — |
| Example 3 | 40 (35 μm) | 19 (35 μm) | 12 (116 μm) | — | 14 (6 μm) | 15 (3 μm) | 15 (40 μm) | — |
| Example 4 | 40 (35 μm) | 19 (35 μm) | 12 (116 μm) | — | 14 (6 μm) | 15 (3 μm) | 20 (40 μm) | — |
| Example 5 | 40 (35 μm) | 19 (35 μm) | 12 (116 μm) | — | 14 (6 μm) | 15 (3 μm) | 20 (50 μm) | — |
| Example 6 | 40 (35 μm) | 19 (35 μm) | — | 23 (131 μm) | 14 (6 μm) | 15 (3 μm) | 20 (50 μm) | — |
| Example 7 | 40 (35 μm) | 19 (35 μm) | — | 23 (131 μm) | 14 (6 μm) | 15 (3 μm) | 20 (80 μm) | — |
| Example 8 | 40 (35 μm) | 19 (35 μm) | — | 23 (131 μm) | 14 (6 μm) | 15 (3 μm) | 20 (100 μm) | — |
| Comp. Ex. 1 | 40 (35 μm) | 19 (35 μm) | — | 23 (131 μm) | 14 (6 μm) | 15 (3 μm) | — | 20 (150 μm) |

TABLE 2

| | Partition wall | | | | |
|---|---|---|---|---|---|
| | thickness | Cell density | | Mean pore diameter | |
| | μm | cells/in² | Porosity % | μm | Forming state |
| Example 1 | 430 | 100 | 49 | 57 | Good |
| Example 2 | 430 | 100 | 50 | 63 | Good |
| Example 3 | 430 | 100 | 45 | 58 | Good |
| Example 4 | 430 | 100 | 51 | 66 | Good |
| Example 5 | 430 | 100 | 51 | 77 | Good |
| Example 6 | 430 | 100 | 52 | 82 | Good |
| Example 7 | 640 | 100 | 54 | 98 | Good |
| Example 8 | 760 | 50 | 56 | 104 | Good |
| Comp. Ex. 1 | 430 | 100 | 46 | 44 | Forming pressure |
| | | | | | rose. |

A method for manufacturing a honeycomb structure of the present invention is suitably used as a means for manufacturing a honeycomb catalyst body suitably used for purifying components to be purified such as carbon monoxide (CO), hydrocarbon (HC), nitrogen oxide (NOx), and sulfur oxide (SOx) contained in exhaust gas exhausted from stationary engines for automobiles, construction machinery, or industry; combustion apparatus; or the like.

In addition, a honeycomb structure obtained by a method for manufacturing a honeycomb structure of the present invention is suitable as a filter structure for treating water, for a separation film, or the like. A method for manufacturing a honeycomb structure of the present invention is suitably used as a means for manufacturing a filter for treating water or a filter for a separation film.

What is claimed is:

1. A method for manufacturing a honeycomb structure comprising the steps of:
mixing and kneading a material for clay containing a ceramic raw material, a binder, and water to obtain clay,
forming the clay into a honeycomb shape having a plurality of cells communicating between two end faces thereof and being formed with partition walls to obtain a honeycomb formed body, and
firing the honeycomb formed body to obtain a honeycomb structure;
wherein a raw material containing Al₂O₃ is used as the ceramic raw material, and a low melting point reacting substance is allowed to be contained in the clay at least before being formed to obtain a honeycomb structure having a mean pore diameter of 20 to 500 μm as the honeycomb structure.

2. A method for manufacturing a honeycomb structure according to claim 1, wherein the low melting point reacting substance is powdery or fibrous, and a size of a powdery particle or that of a fiber is 10 to 200 μm.

3. A method for manufacturing a honeycomb structure according to claim 1, wherein the low melting point reacting substance is of metal.

4. A method for manufacturing a honeycomb structure according to claim 3, wherein the metal is one metal, an alloy containing as a main component at least one metal, or an alloy containing as a main component two or more metals selected from the group consisting of iron, copper, zinc, lead, aluminum, and nickel.

5. A method for manufacturing a honeycomb structure according to claim 1, wherein a low melting point reacting substance is added to the ceramic raw material in advance to allow the low melting point reacting substance to be contained in the clay at least before being formed.

6. A method for manufacturing a honeycomb structure according to claim 1, wherein a mold is used upon forming, and a screen formed of the low melting point reacting substance is disposed in front of a die of the mold to pass the clay through the screen before the clay is passed through the die to allow the low melting point reacting substance contained in the clay at least before being formed.

7. A method for manufacturing a honeycomb structure according to claim 1, wherein a honeycomb structure having a porosity of 40 to 80% is obtained as the honeycomb structure.

8. A method for manufacturing a honeycomb structure according to claim 1, wherein a honeycomb structure having a partition wall thickness of 50 to 2000 μm is obtained as the honeycomb structure.

9. A method for manufacturing a honeycomb structure according to claim 1, wherein a honeycomb structure having a cell density of 20 to 1500 cells/in² is obtained as the honeycomb structure.

10. A method for manufacturing a honeycomb catalyst body, wherein a plugged portion is formed so as to plug the cells of the honeycomb structure on any of the end faces aster the honeycomb structure is obtained in a method for manufacturing a honeycomb structure according to claim 1, and a catalyst layer is formed on an inside surface of the cells and an inside surface of the pores in the partition walls forming the cells to obtain a honeycomb catalyst body.
